(19) United States
(12) Patent Application Publication
(10) Pub. No.: US 2012/0124629 A1
(43) Pub. Date: May 17, 2012

(54) Managing Bandwidth in an IPTV Environment

(76) Inventor: Roger Musick, Mitchell, SD (US)

(21) Appl. No.: 12/944,806

(22) Filed: Nov. 12, 2010

(51) Int. Cl. H04N 7/173

(52) U.S. Cl. 725/95; 725/131

(57) ABSTRACT

Bandwidth in an IPTV environment is managed by determining when the available bandwidth may be exceeded if a new video stream is added, and, prior to exceeding the available bandwidth, choosing a particular video stream to halt. The user of the particular video stream is then asked for permission to halt the particular video stream and then the video stream is halted before starting to receive the new video stream.

### BACKGROUND

1. Technical Field

This invention generally relates to television systems, and more particularly relates to Internet Protocol television systems.

2. Description of Related Art

Bandwidth limitations in a digital video system may limit the number of video streams that can simultaneously be transmitted to a customer premises. Moreover, it is possible for the users within a single customer premises to request a set of digital video streams that would exceed the bandwidth limitation. If this were to occur, not all of the streams could be transmitted in real time causing disruptions to the viewing experience for the users.

### SUMMARY

A method, apparatus and system for managing digital video bandwidth is disclosed herein. An available bandwidth on a video connection for receiving video streams is established. A digital video receiver may receive a request for a new video stream and calculate that an amount of bandwidth required for a requested set of video streams that includes the new video stream would exceed the available bandwidth for receiving video streams. A proposed set of video streams is selected that includes the new video stream but does not include a particular video stream of the requested set of video streams so that an amount of bandwidth required for the proposed set of video streams does not exceed the available bandwidth for receiving video streams. A consuming device of the particular video stream is identified and permission to halt the particular video stream may be requested from the consuming device. The video connection is configured to transmit the new video stream after the permission is received from the consuming device to halt the particular video stream.

### BRIEF DESCRIPTION OF THE DRAWINGS

The accompanying drawings, which are incorporated in and constitute part of the specification, illustrate various embodiments of the invention. They should not, however, be taken to limit the invention to the specific embodiment(s) described, but are for explanation and understanding only. In the drawings:

FIG. 1 shows a block diagram of an embodiment of a digital video system;

FIG. 2 shows a block diagram of a particular embodiment of a digital video receiver;

FIG. 3 is a flow chart of a particular embodiment of a method of managing bandwidth in a digital video environment;

FIG. 4 is a flow chart of a particular embodiment of asking permission from a user to halt a digital video stream; and

FIG. 5 is a flow chart of a particular embodiment of informing a user of how to upgrade their service.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures and components have been described at a relatively high-level, without detail, in order to avoid unnecessarily obscuring aspects of the present concepts. A number of descriptive terms and phrases are used in describing the various embodiments of this disclosure. These descriptive terms and phrases are used to convey a generally agreed upon meaning to those skilled in the art unless a different definition is given in this specification.

Reference now is made in detail to the examples illustrated in the accompanying drawings and discussed below.

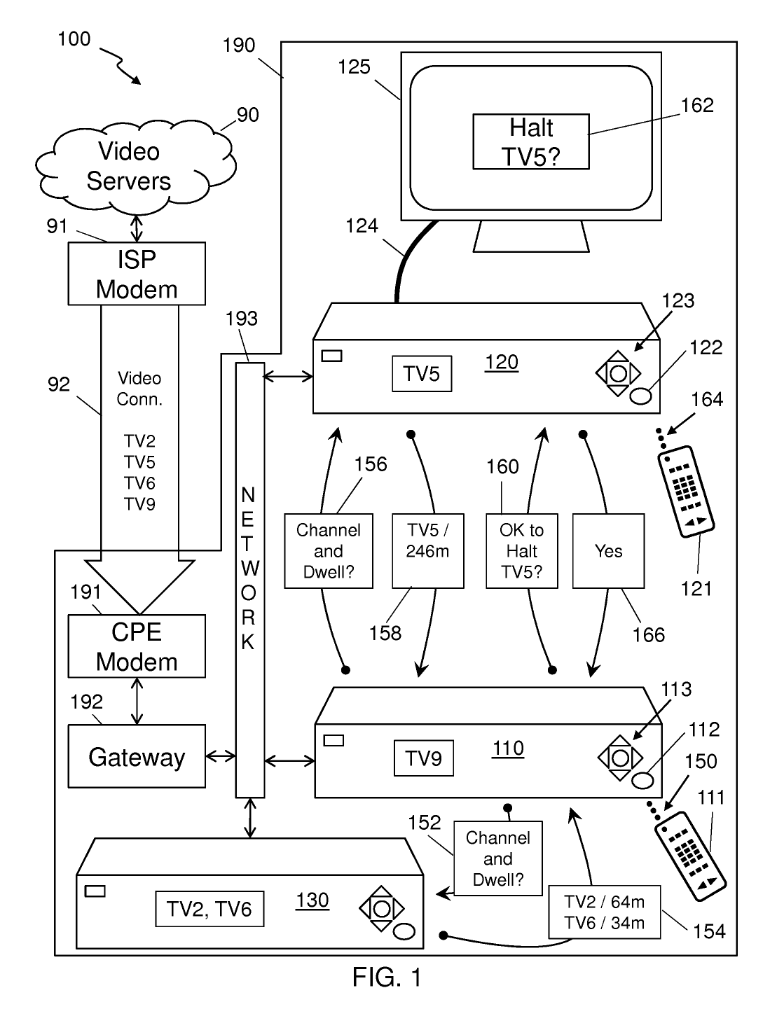

FIG. 1 is a block diagram of a digital video system 100 showing a customer premises 190 with a video connection 92 for receiving video streams. In some embodiments, the video connection 92 may utilize an internet protocol (IP) and the video streams may be digital video compressed using a compression algorithms developed by the motion pictures experts group (MPEG 2 & MPEG 4), H.264 or other digital compression techniques. The video connection 92 may sometimes be referred to as an internet protocol television (IPTV) connection. The video connection 92 may utilize wired, optical, wireless, hybrid solutions, or other communication methods. Wired communication protocols may include, but are not limited to, Data Over Cable Service Interface Specification (DOCSIS), Asynchronous Digital Subscriber Line (ADSL), Very high-speed Digital Subscriber Line (VDSL), Power Line Communication (PLC) or ethernet technologies. Optical communication protocols may include, but are not limited to SONET, SDH, wavelength division multiplexing, or other technologies. Wireless communication protocols may include, but are not limited to, Wi-Max, satellite communication, 3G and 4G cellular technology, Wi-Fi, Multichannel Multipoint Distribution Service (MMDS), or other technologies. The video connection 92 may connect to a modem 91 of an internet service provider (ISP). The ISP may provide connection to video servers 90 that may be operated by the ISP or may be operated by another entity such as a television service provider. The video servers 90 may be connected to the ISP modem 91 through a local private network, an extended private network, a public network such as the internet, or some other type of connection. The video servers 90 may store video streams in a static form or they may provide real-time (or near-real time) access to a live video stream. The video servers 90 may provide for video on demand (VOD) services and/or scheduled programming options.

The video connection 92 may have a limited bandwidth so that only a limited number of video streams can be transmitted. In some embodiments the entire limited bandwidth of the video connection 92 may be available bandwidth for video streams. In other embodiments, the limited bandwidth of the video connection 92 may be shared among multiple uses, such as internet connectivity and/or Voice Over IP (VOIP) services in addition to the video streams. An allocation may be made to assign a minimum amount of the limited bandwidth to the other services leaving only an available bandwidth for video streams. In one embodiment, the video connection 92 may have 25 Mb/s of limited bandwidth. A user or system operator may determine that 5 Mb/s of that bandwidth should be assigned to non-video uses leaving only 20 Mb/s of bandwidth available for video streams. The available bandwidth may be able to support multiple video streams. The bandwidth required for a video stream may depend on a number of factors, including the resolution of the video streams and the compression technology used. For example, high definition (HD) video streams typically require more bandwidth than a standard definition (SD) video stream and, for a given resolution, MPEG 2 video streams may require more bandwidth than MPEG 4 video streams. In one embodiment an HD video stream utilizing MPEG4 may require 8 Mb/s of bandwidth and an SD video stream utilizing MPEG2 may require 3.2 Mb/s of bandwidth. So in an embodiment with 20 Mb/s of bandwidth available for video streams, several different combinations of video streams may be transmitted. A set of up to 6 SD video streams, a set of 1 HD video stream and up to 3 SD video streams, or a set of 2 HD video streams and up to 1 SD video stream may be simultaneously transmitted in the 20 Mb/s available bandwidth. For the purposes of this disclosure, simultaneously should not be strictly interpreted. “Simultaneously” as used to describe the video streams herein, is meant to describe a case where two or more video streams may be sent so that over a period of time, the two or more video streams displayed without disruptions due to lack of data. The two or more video streams may have be buffered in memory or to a mass storage device to allow for some level of asynchronous delivery of the IP packets that may make up the video streams.

The customer premises 190 may contain multiple devices including a customer premises equipment (CPE) modem 191 that connects the video connection 92 to a gateway device 192. In some embodiments, the CPE modem 191 and the gateway device 192 may be integrated into a single unit and in other embodiments, they may be implemented as separate devices connected by ethernet, universal serial bus (USB) or other connection. The gateway device 192 may connect to a network 193. The network 193 may be a single network or it may be two or more networks with bridging and/or routing functionality connecting them. The network(s) 193 may utilize ethernet, Wi-Fi, Power Line Communication, Multimedia over Coax Alliance (MOCA) or other networking technologies. One or more digital video receivers 110, 120, 130 may also connect to the network 193 allowing them to receive video streams transmitted on the video connection 92, through the CPE modem 191 and gateway device 192 over the network 193. Other devices such as, but not limited to, personal computers, servers, tablets, personal data assistants (PDAs), internet-enabled televisions, internet radios, or other devices, may connect to the network 193 and may access the internet through the gateway 192, CPE modem 191 and video connection 92. In many embodiments, the bandwidth of the network 193 may exceed the total bandwidth of the video connection 92 so that no bottleneck is created by the network 193. In some embodiments, the network 193 may provide a lower bandwidth than the video connection 92 and the available bandwidth for video streams would need to be adjusted based on the lower bandwidth of the network 193.

One or more digital video receivers 110, 120, 130 may receive zero, one or more video streams each at any given time. A first digital video receiver 110 may be connected to a display (not shown). In some embodiments, a digital video receiver may be integrated into a display to create an integrated IPTV set. A second digital video receiver 120 may connect to a display 125 by a video cable 124. The display 125 may be a cathode ray tube (CRT) display, a light emitting diode display, a liquid crystal display (LCD), plasma display, or other display suitable for watching video. The video cable 124 may be one or more coaxial cables, a high definition multimedia interface (HDMI) cable, a video graphic array (VGA) cable, or other cable capable of transmitting the video signal to the display 125. A third digital video receiver 130 may include a digital video recorder (DVR) and may also be connected to a display (not shown). The digital video receivers 110, 120, 130 may have equivalent functionality or may have somewhat different features, such as a DVR. They may function as peers on the network 193 and have the ability to communicate with each other over the network 193, or over other communication paths such as using a dedicated wired connection, wireless communication, or IR communication.

The exemplary digital video system 100 shown in FIG. 1 has four active video streams being transmitted on the video connection 92 at a given time. TV9, an SD video stream, is being received by the first digital video receiver 110 while TV5, an HD video stream is being received by the second digital video receiver 120. The third digital video recorder 130 is receiving two SD video streams, TV2 and TV6, which it may be recording on its DVR. The digital video receivers 110, 120, 130 may be keeping track of the dwell time for each video stream. Dwell time is a parameter indicating a length of time that a given video stream has been received by a given digital video receiver. Other parameters related to the video streams may also be logged including, but not limited to, time since the last user activity (e.g. remote control button push), a priority level setting for the video stream, a priority level of the DVR recording of that stream, an amount of time until a recording may start, an amount of time until a recording may finish, or any other parameter related to the video streams.

A user may press a channel up button on a first remote control 111 paired with the first digital video receiver 110 causing a channel up infrared (IR) command 150 to be sent to the IR receiver 112 of the first digital video receiver 110. Other embodiments may use a remote control 111 utilizing radio frequency communication. This may be processed and interpreted as a request to stop reception of TV9 and to start receiving a new video stream, TV10, a HD video stream. Other events could cause a request for a new video stream such as a user entering a particular channel number on the remote control 111 or pressing one of the buttons 113 on the front of the first digital video receiver 110, a timer event to turn on the attached display to use as an alarm clock, a DVR timer event to start a new recording, or other events. Each digital video recorder 110, 120, 130, may not have information about what video streams are currently being transmitted on the video connection 92 as there may be no central controller in the customer premises 190 for the digital video system 100. So in response to the new video stream request, the first digital video receiver 110 may communicate with the other digital video receivers 120, 130 in the digital video system 100 to determine what video streams they are currently using. A message 152 asking for information about the video streams being used, including channel ID and dwell time, maybe sent over the network 193 to the third digital video receiver 130 which may respond with a message 154, also sent over the network 193, detailing that TV2 with a dwell time of 64 minutes and TV6 with a dwell time of 34 minutes are being recorded. Other information related to the video streams such as, but not limited to, video stream being sent to display, video stream being recorded, priority level of the stream, priority level of the recording, time since last user input, or other information may also be exchanged between the digital video receivers 110, 130. The digital video receiver 110 may also send a message 156 to the second digital video receiver 120 over the network 193 asking for information about the video streams it is consuming. The second digital video receiver 120 may respond by sending message 158 over the network 193 detailing that TV5 with a dwell time of 246 minutes is being displayed.

Once the first digital video receiver 110 has queried the other devices in the digital video system 100, it may determine a bandwidth requirement for each video stream. In some embodiments, the first digital video receiver 110 may have a table of potential video streams and their associated bandwidths stored in memory. In other embodiments, the bandwidth used by each video stream may be provided by the digital video receivers 110, 120, 130 receiving the video stream. In other embodiments, the first digital video receiver 110 may access information from the internet or from the video servers 90 to determine the bandwidth requirements for each video stream. Once the bandwidth requirements for each video stream are known, the first digital video receiver may calculate an amount of bandwidth required for a requested set of video streams. The requested set of video streams includes the new video stream and the video streams currently being transmitted on the video connection 92 except for any video stream being inherently replaced by the new video stream. An old video stream is inherently replaced if the new video stream may be substituted for it such as when a viewed channel is replaced with a new channel being viewed when a channel up or channel down button is pressed. So for the system shown in FIG. 1, the requested set of video streams would include the new video stream, TV10, requiring 8 Mb/s, TV2, requiring 3.2 Mb/s, TV6, requiring 3.2 Mb/s and TV5, requiring 8 Mb/s, but would not include TV9 because it is being replaced by TV10. So the requested set of video streams in this example would require 22.4 Mb/s which exceeds the 20 Mb/s of available bandwidth on the video connection. Note that if TV10 had been an SD video stream, the bandwidth required for the requested set of video streams would have been less than the available bandwidth so that the first digital video receiver 110 could have simply halted TV9 and started reception of TV10. But since the HD stream causes the bandwidth to exceed the available bandwidth, more action is required to maintain a good user experience.

Once the first digital video receiver 110 has calculated that the bandwidth required for the requested set of video streams would exceed the available bandwidth on the video connection 92, it may try to determine a particular video stream of the requested set of video streams to halt, in order to create a proposed set of video streams that does not exceed the available bandwidth. It may use the other information about the video streams, such as the dwell times, priorities, user activity, etc. in making this determination. In this example, TV5 is chosen as the particular video stream to halt because it has the longest dwell time so it may be the video stream that is least likely to still be watched. Once the particular video stream to halt has been identified it is eliminated from the requested set of video streams to create the proposed set of video streams and the bandwidths required for the proposed set of video streams is calculated and compared against the available bandwidth to ensure that the proposed set of video streams can be simultaneously transmitted on the video connection 92.

A consuming device of the particular video stream may then be identified using the information received from the digital video receivers 110, 120, 130. In some cases it may be possible that the consuming device of the particular video stream is the first digital video receiver 110 but in the example described here, the consuming device of the particular video stream is the second digital video receiver 120. The first digital video receiver 110 may then send a message 160 to the second digital video receiver 120 over the network 193 requesting permission to halt TV5. Upon reception of the message 160, the second digital video receiver 120 may display a message 162 on the display 125 asking for the user's permission to halt the current video stream, TV5. The user may respond using the second remote control 121 to send an approval IR message 164 to the IR receiver 122 on the second digital video receiver 120. The user may also use buttons 123 on the front of the second digital video receiver 120 to respond. In some cases, the user may not be in the room and not provide any response, so a timeout may be required to allow the second digital video receiver to respond in a timely way. Once the user's approval, such as approval IR message 164, has been received (or the timeout occurs), the second digital video receiver may send a message 166 over the network 193 giving permission to halt TV5. The transmission of TV5 may be halted by the first digital video receiver 110 in some embodiments or by the second digital video receiver 120 in other embodiments. After the transmission of the particular video stream, TV5, and the old video stream being replaced TV9, have been halted, the video connection 92 is then configured by the first digital video receiver 110 to start transmitting the new video stream, TV10. This allows the video streams being transmitted on the video connection 92 to require less bandwidth than the available bandwidth to provide the best user experience possible.

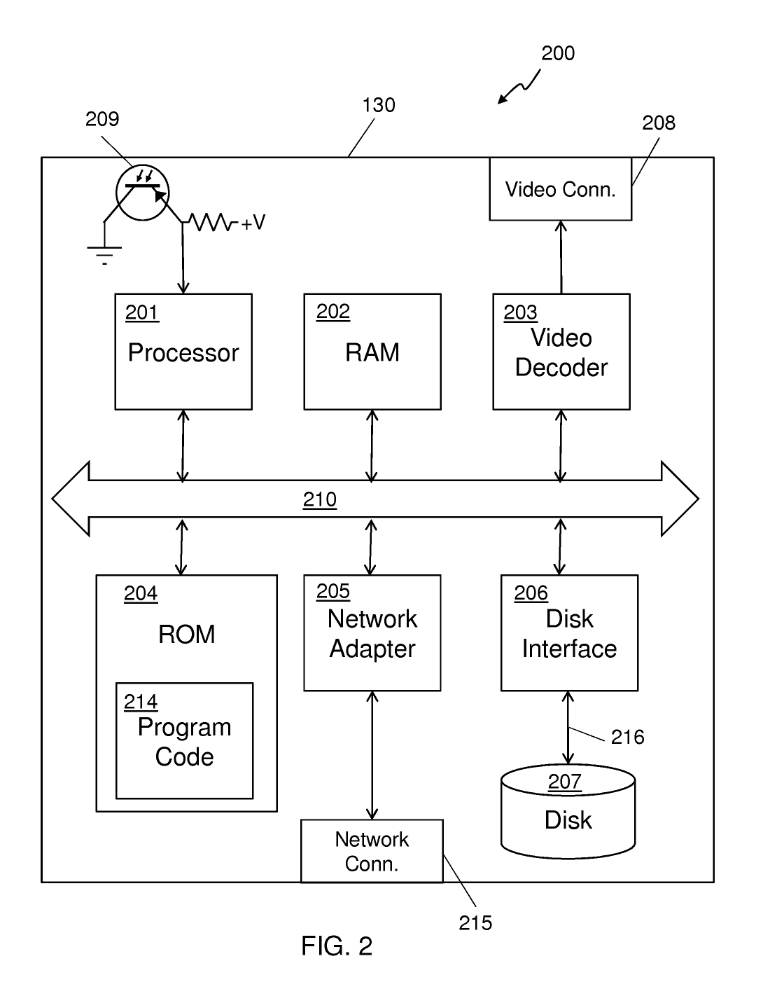

FIG. 2 shows a block diagram 200 of an embodiment of the third digital video receiver 130. The block diagram may also apply to the first digital video receiver 110 and/or second digital video receiver 120 of FIG. 1. The digital video receiver 130 includes a processor 201 in communication with a digital communications bus 210 allowing the processor 201 to communicate with other blocks that are also in communication with the digital communication bus 210. Random Access Memory (RAM) 202 may also be in communication with the digital communication bus 210 so that the processor 201 or other blocks may store and/or retrieve data in the RAM 202. The RAM 202 may be integrated with the processor 201 and/or other blocks or it may be implemented as a discrete function using synchronous dynamic random access memory (SDRAM) chips, double data rate (DDR) RAM chips or other types of RAM.

A network adapter 205 may also be in communication with the digital communications bus 210. The network adapter 205 may support a wired network such as ethernet or it may support a wireless network such as Wi-Fi or any other sort of network. The network adapter 205 may connect to the network using a connector 215 or antenna (not shown). Some embodiments may have multiple network adapters 205 to allow them to connect to a variety of different networks. A video decoder 203 may also be in communication with the digital communications bus 210 with the capability to decompress digital video streams such as MPEG2 and/or MPEG4 video streams. The video decoder 203 may generate a video output at a video connector 208 suitable for connecting to a display device. A disk interface 206 may be in communication with the digital communications bus 210 and to a disk interface cable 216 allowing the processor 201 to access a disk 207 for storage and retrieval of data such as recording of video streams. The disk interface 206 may utilize a standard protocol such as a serial advanced technology attachment (SATA) or small computer system interface (SCSI) or any other standard or proprietary interface. The disk 207 may utilize a rotating magnetic medium, a rotating optical medium, a bank of non-volatile memory such as NAND Flash or NOR Flash, a bank of battery backed up volatile memory such as SDRAM, or any other type of non-volatile memory.

Read Only Memory (ROM) 204 may also be in communication with the digital communications bus 210. The ROM may be a mask programmed ROM, a one-time programmable ROM, NAND Flash, NOR Flash or any other type of non-volatile memory. Program code 214 may be stored in a non-transitory processor readable storage medium such as ROM 204, disk 207, or RAM 202. The program code 214 may be read and executed by the processor 201. An optical IR receiver 209 suitable for receiving remote control commands may be in communication with the processor 201 to enable the processor to receive commands from a remote control. One skilled in the art may understand that many other variations of a system architecture may be utilized for the digital video receiver and that different embodiments may integrate different sets of blocks onto a single chip.

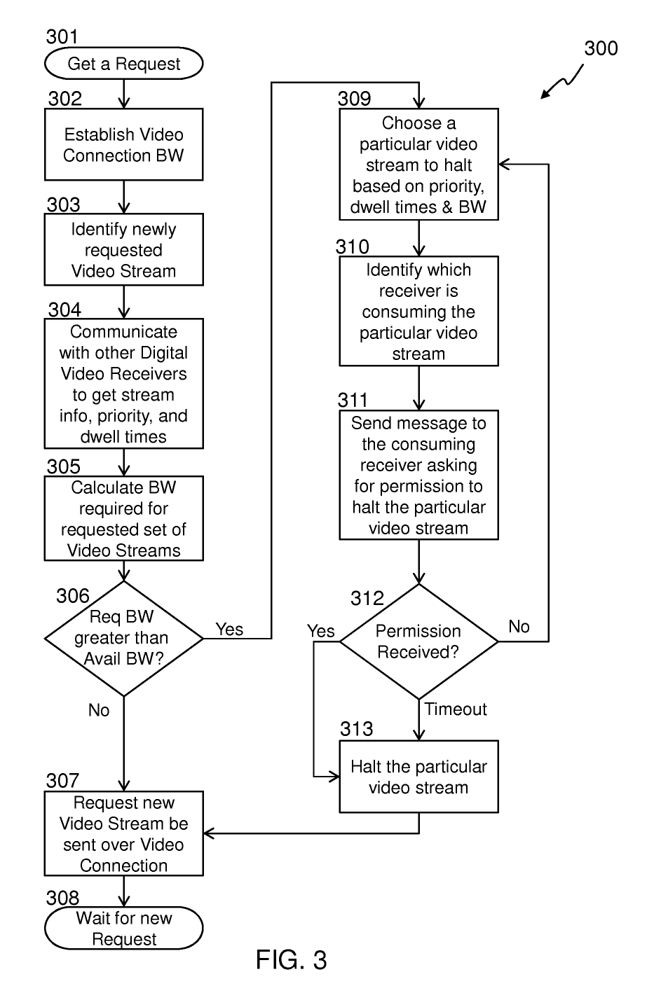

FIG. 3 is a flow chart 300 of a particular embodiment of a method of managing bandwidth in a digital video environment. At block 301, a request may be received for a new video stream at a first digital video receiver 110. The request may originate from a button press on a remote control 111 or a front panel button 113 in some embodiments, or may originate from a timer in other embodiments, such as a timer to start a new DVR recording. The first digital video receiver 110 may establish an available bandwidth of a video connection 92 for receiving video streams at block 302. In some embodiments, the video streams may be digital and the video connection 92 may utilize an internet protocol (IP). A new video stream that is being requested may be identified in block 303. The new video stream may replace an old video stream as is the case for the displayed video stream if a channel up or channel down button is pressed. In other embodiments, such as a timer event for a new DVR recording, the new video stream may not necessarily displace another video stream.

At block 304, the first digital video receiver 110 may communicate over the network 193 with other digital video receivers 120, 130 that may share the video connection. Information on which video streams are being used by the other digital video receivers 120, 130 as well as parameters related to the video streams such as the bandwidth used, a dwell time of the video stream, a priority of the video stream, a time since the last user input, or other parameters may be gathered. Once the information on the video streams in use has been gathered, the first digital video receiver 110 may calculate the bandwidth required for the requested set of video streams in block 305. The requested set of video streams may include the video streams being received by the other digital video receivers 120, 130 as well as the streams being received by the first digital video receiver 110 excluding any stream being replaced by the newly requested video stream. The amount of bandwidth required for the requested set of video streams may then be compared to the available bandwidth on the video connection 92 in block 306. If the bandwidth required for the requested set of video streams is not greater than the available bandwidth, the first digital video receiver 110 may halt the old video stream being replaced and then request that the new video stream be sent over the video connection 92 in block 307. The first digital video receiver 110 may then wait for the next new request in block 308.

If the bandwidth required for the requested set of video streams is greater than the available bandwidth, a particular video stream may be chosen at block 309 to be halted to free up enough bandwidth to allow the new video stream to be sent without exceeding the available bandwidth on the video connection 92. In some embodiments the parameters related to the video streams received by the other digital video receivers 120, 130, as well as parameters related to the video streams received by the first digital video receiver 110, may be used to choose the particular video stream to be halted. In some embodiments, the video stream with the longest dwell time may be chosen as the particular video stream. In other embodiments, a table mapping dwell times to a probability of a user still watching the video stream may be used to choose the particular video stream. One embodiment of such a table might map a dwell time of 0-10 minutes to a probability of 90%, 11-25 minutes to a probability of 70%, 26-62 minutes to a probability of 75%, 62-95 minutes to a probability of 50%, 95-125 minutes to a probability of 65%, 126-190 minutes to a probability of 40%, 191-250 minutes to a probability of 33%, and 251+ minutes to a probability of 10%. Other embodiments may use heuristics to create a table with a custom mapping of dwell time to probability of a user watching the video stream. The video stream with the lowest probability may then be chosen as the particular video stream.

In another embodiment, the video stream may be chosen from the digital video receiver 110, 120, 130 with the longest time since a user input (e.g. remote control 111, 121 button or front panel button 113, 123 press) has been received. If the digital video receiver 110, 120, 130 with the longest time since a user input has been received is receiving multiple video streams, a video stream may be chosen from the video streams being received by that digital video receiver 110, 120, 130 with the longest dwell time or the lowest probability of a user watching. In other embodiments, the video stream with the lowest overall priority may be chosen as the particular video stream to halt, where the priority level may be set by a user action, information from the video servers, or other information. In some embodiments, the bandwidth used by the video streams may be considered in choosing the particular video stream; a stream with a bandwidth at least as high as the new video stream requires may be chosen. Other embodiments, may utilize a parameter describing how the video stream is being used (e.g. being displayed vs being recorded) and may also utilize a recording priority and/or the availability to record the program at another time in choosing the particular video stream to be halted. Any number of parameters related to the video stream may be used or combined in any number of algorithms to choose the particular video stream to be halted.

The bandwidth required for a proposed set of video streams that includes the new video stream but eliminates the particular video stream should be less than the available bandwidth on the video connection 92. If the particular video stream chosen may not free up enough bandwidth to allow the new video stream to be added without exceeding the available bandwidth, additional particular video streams may need to selected so that if the set of particular video streams are halted, enough bandwidth may be freed up to allow the new video stream to be included in the proposed set of video streams without exceeding the available bandwidth on the video connection 92.

Once the particular video stream to halt has been chosen in block 309, the first digital video receiver 110 may determine which digital video receiver 110, 120 130 is currently consuming the particular video stream in block 310. This may be accomplished by examining the information received from the other digital video receivers 120, 130 or by sending out new queries asking the digital video receiver 110, 120, 130 that is receiving the particular video stream to identify itself. In some cases, the consuming device may be the first digital video receiver 110 itself, while in other cases, the consuming device may be another digital video receiver 120, 130 or other device on the network. Once the consuming digital video receiver 110, 120, 130 (or consuming device) has been identified, the first digital video receiver 110 may send a message over the network 193 to the consuming device asking permission to halt the particular video stream in block 311. The first digital video receiver 110 may then wait for a response from the consuming device over the network 193 at block 312. If the response denies permission to halt the particular video stream, the first digital video receiver 110 may then go back to block 309 and chose a different particular video stream to halt. In other embodiments, the first digital video receiver 110 may ask the user of the first digital video receiver 110 to choose a different particular video stream to halt from the set of requested video streams. In yet another embodiment, the video receiver 110 may display a message to the user that the change request cannot be fulfilled.

If the first digital video receiver 110 receives permission to halt the particular video stream, or if a timeout period (typically several seconds to give time for a user of the particular video stream to respond) elapses without receiving a response, the first digital video receiver 110 may halt the particular video stream in block 313. In other embodiments the particular video stream may be halted by the consuming device so that the first digital video receiver 110 does not need to halt it. Then the video connection 92 may be configured by the first digital video receiver 110 to start transmitting the new video stream at block 307 and the first digital video receiver 110 may wait for the next request at block 308.

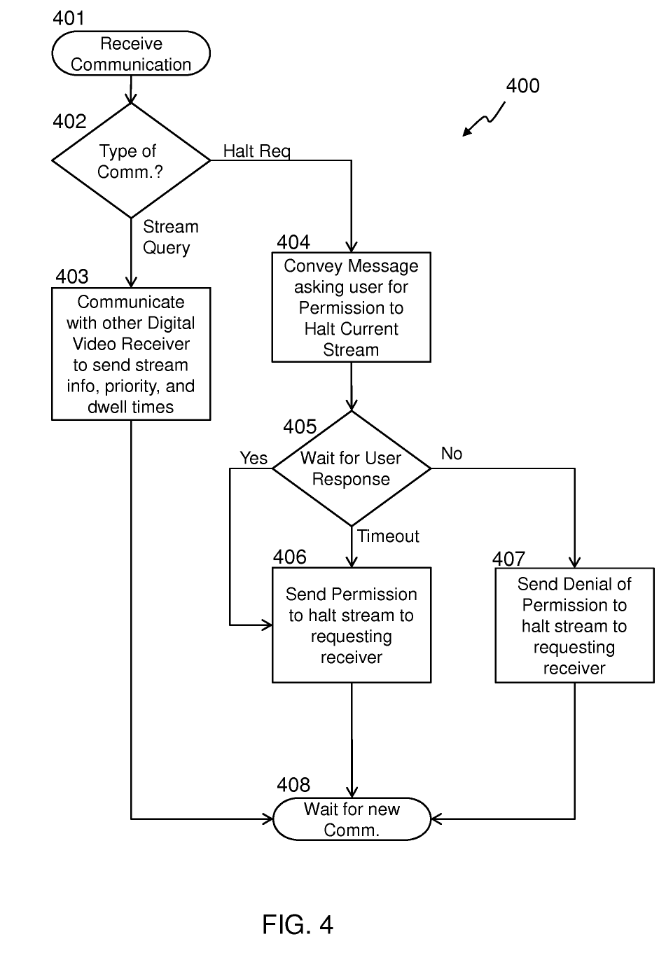

FIG. 4 is a flow chart 400 of a particular embodiment where a second digital video receiver 120 may receive communication over the network 193 from a first digital video receiver 110 at block 401. The second digital video receiver 120 may then determine what type of communication has been received at block 402. If the communication is a query as to which video streams are being received by the second digital video receiver 120, a response may be sent over the network 193 at block 403 with information about the video streams being received. The information may include an identifier of the video stream(s) being received, bandwidth information about the streams, dwell times of the streams, elapsed time since an input from the user has been received, priority information or any other parameters about the video streams. The second digital video receiver 120 may then wait for the next communication at block 408.

If the communication is a request to halt a particular video stream from the first digital video receiver 110, the second digital video receiver 120 may convey a message at block 404 asking permission from a user to halt the particular digital video stream. The message may be superimposed over the current video displayed on a connected display, it may replace the current video, or it may be blended into the current video. In other embodiments the message may be displayed on a special purpose display that may be included on the front of the second digital video receiver 120. In other embodiments, the message may be an audible request mixed with or replacing the audio track of the current video. The second digital video receiver 120 may then wait for a user response at block 405. The user response may be sent with a press of a button on a remote control 121, a press of a button 123 on the front of the second digital video receiver 120, an audible response received through a microphone, a gesture received through a camera, or any other type of user response. If the user denies the request to halt the particular video stream, the second digital video receiver 120 may send a denial of permission to the first digital video receiver 110 over the network 193 at block 407 and then wait for the next communication at block 408. If the user responds with permission to halt the particular video stream, or if a timeout (typically several seconds) elapses without any response from the user, the second digital video receiver 120 may send permission over the network 193 to the first digital video receiver 110 to halt the particular video stream at block 406. In some embodiments, the second digital video receiver 120 may halt the particular video stream itself. Once permission has been sent, the second digital video receiver 120 may wait for another communication at block 408.

In the digital video system 100 shown in FIG. 1, a customer premises 190 may have three digital video receivers that may each receive up to 2 simultaneous video streams (1 for display and one for recording on the DVR). So theoretically, 6 simultaneous 8 Mb/s streams could be requested at a given time for a total of 48 Mb/s. While it may be technically possible to provide the customer premises 190 with 48 Mb/s of available bandwidth, the service provider may want to provide different levels of service at different price points. A first price point may provide only 8 Mb/s of available bandwidth on the video connection 92 allowing only a single HD or two SD video streams to be sent simultaneously. A second price point may provide 20 Mb/s of available bandwidth on the video connection 92 and a third price point may provide 40 Mb/s of available bandwidth on the video connection 92. A user may be able to choose which price point they want based on the number of digital video receivers 110, 120, 130 they are going to use and their expected viewing habits. But in some cases, a user may choose a price point that does not provide enough available bandwidth to service their actual usage patterns.

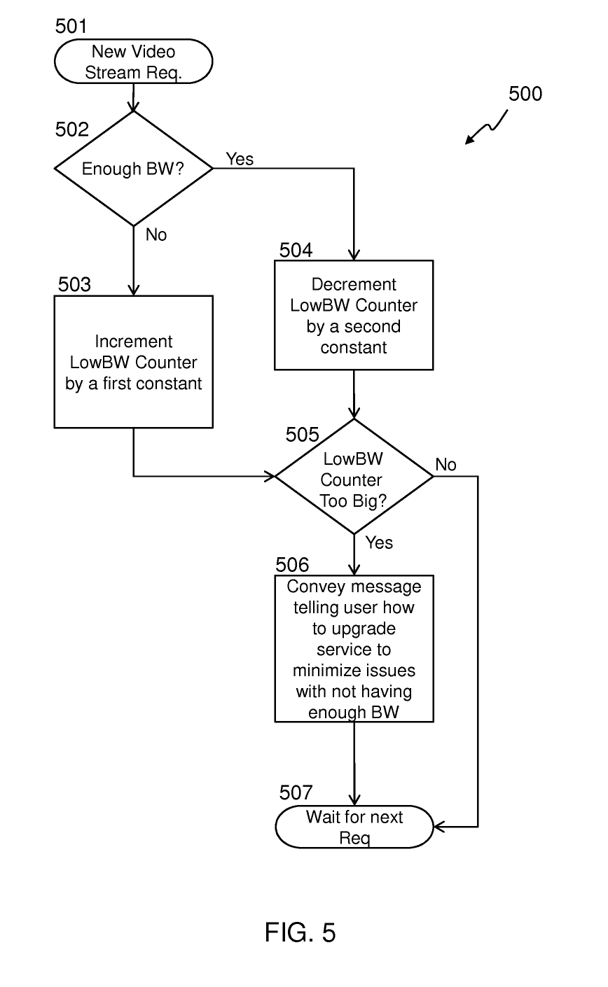

FIG. 5 is a flow chart 500 of a particular embodiment of informing a user of how to upgrade their service in the case where they often need to halt a desired video stream in order to receive a new video stream. A counter, named LowBW in this embodiment, may be maintained by the first digital video receiver 110 that may be reset at initialization and/or other times. The LowBW counter may be used as an upgrade indicator as it may track how often the available bandwidth for receiving video streams is less than the amount of bandwidth required for the requested set of video streams. A request for a new video stream may be received by the first digital video receiver 110 at block 501 and, using the method described in the flowchart 300, it may be determined at block 502 if the available bandwidth is large enough to allow the new video stream to be transmitted on the video connection 92 without halting a video stream other than an old video stream that is being replaced by the new video stream such as is the case for channel up or channel down. If there is not enough available bandwidth to accommodate the new video stream, the LowBW counter may be incremented by a first constant at block 503. If there is enough available bandwidth to accommodate the new video stream, the LowBW counter may be decremented by a second constant at block 504.

The LowBW counter may be evaluated at block 505 to determine if it is too large, indicating that the users commonly need to halt a video stream in use to accommodate a requested new video stream. If the LowBW counter is too large, a message may be conveyed to the user at block 506 informing them how they may upgrade their service to provide a larger available bandwidth on their video connection 92. The message may be displayed on a connected display superimposed over the current video, replacing the current video, or blended into the current video. In other embodiments the message may be displayed on a special purpose display that may be included on the front of the first digital video receiver 110. In other embodiments, the message may be an audible message mixed with or replacing the audio track of the current video. In some embodiments the message may be a paper information packet physically mailed to the customer premises 190. In some embodiments the user may be presented with an easy method of upgrading their service, such as pressing the OK button on their remote control 111. In other cases a password or personal identification number (PIN) may need to be entered to authorize the upgrade. In other embodiments the user may need to call a displayed number or take other action to upgrade their service. If the LowBW counter is not too large, the first digital video receiver 110 may wait for the next request for a new video stream at block 507. Other algorithms may be used in other embodiments to track how often the particular video stream needs to be halted to allow the new video stream to be transmitted.

The ratio of the first constant to the second constant may be chosen based on a desired percentage of the time where a particular video stream needs to be halted to allow for a new video stream to be added before the user is presented with an upgrade opportunity. As an example, if it were to be determined that most users may desire to upgrade their service if 25% of the time that they change channels another desired video stream needs to be halted, the first constant, used to increment the LowBW counter if a particular video stream needs to be halted may, may be set to 3, and the second constant, used to decrement the LowBW counter if a change is made that does not require a particular video stream to be halted, may be set to 1. So if over a period of time, a particular video stream needs to be halted more than 25% of the time, the LowBW counter increases and at some point the user may be presented with information on how to upgrade their service. In some embodiments the LowBW counter may be reset nightly. In other embodiments, the LowBW counter may be reset after each time the user is presented with an upgrade message. In other embodiments, the user may be able to manually reset the LowBW counter or disable the counter to stop any more upgrade messages from being displayed.

As one example of how this functionality may be used, refer again to the digital video system 100 of FIG. 1 where a video connection 92 may provide 20 Mb/s of available BW and there are three digital video receivers 110, 120, 130 capable of receiving up to 2 SD or HD video streams each. If the user initially only chose SD video streams due to preference, habit or availability, the 20 Mb/s of available bandwidth would allow up to 6 SD video streams to be simultaneously transmitted to the three digital video receivers 110, 120, 130, so there would not be a time that the user could request video streams that could not be delivered, as the three digital video receivers 110, 120 130 may only receive two video streams each. But as more HD video streams become available, and the user starts to choose an HD stream more and more of the time, the available bandwidth on the video connection 92 may only provide up to 2 HD video streams at any one time. So it may become more and more common for the user to be presented with situations where a particular video stream needs to be halted to allow a new video stream to be added.

If the constants are set at 3 and 1 as described above, the LowBW counter is reset each day at midnight, and the method shown in the flowchart 500 displays a message if the LowBW counter exceeds 10, the user may not be presented with an upgrade message in an evening of typical usage as long as a particular video stream does not need to be halted to more than 25% of the time that a new video stream is requested. But as the user begins to use HD video streams more and more, if a third simultaneous HD stream is requested, or a second HD stream is requested if more than 1 SD stream is in use, a particular video stream needs to be halted to accommodate the request, and eventually, the user may be presented with an upgrade message. So if the users of a customer premises 190 are exclusively requesting HD streams, and the three digital video receivers are in use, a user may receive an upgrade message after 4 times of requesting a new channel as each request may cause another video stream to be halted. If the user upgrades their available bandwidth to the next pricing level providing 40 Mb/s of available bandwidth, the video connection 92 would then be able to transmit up to 4 HD streams with 1 SD stream, or 3 HD streams with up to 5 SD streams, providing for a majority of usage scenarios with three digital video receivers capable of receiving 2 simultaneous video streams.

Unless otherwise indicated, all numbers expressing quantities of elements, optical characteristic properties, and so forth used in the specification and claims are to be understood as being modified in all instances by the term “about.” Accordingly, unless indicated to the contrary, the numerical parameters set forth in the preceding specification and attached claims are approximations that can vary depending upon the desired properties sought to be obtained by those skilled in the art utilizing the teachings of the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviations found in their respective testing measurements.

As used in this specification and the appended claims, the singular forms “a”, “an”, and “the” include plural referents unless the content clearly dictates otherwise. Thus, for example, reference to an element described as “an LED” may refer to a single LED, two LEDs or any other number of LEDs. As used in this specification and the appended claims, the term “or” is generally employed in its sense including “and/or” unless the content clearly dictates otherwise.

As used herein, the term “coupled” includes direct and indirect connections. Moreover, where first and second devices are coupled, intervening devices including active devices may be located there between.

Any element in a claim that does not explicitly state “means for” performing a specified function, or “step for” performing a specified function, is not to be interpreted as a “means” or “step” clause as specified in 35 U.S.C. §112, ¶ 6.

The description of the various embodiments provided above is illustrative in nature and is not intended to limit the invention, its application, or uses. Thus, variations that do not depart from the gist of the invention are intended to be within the scope of the embodiments of the present invention. Such variations are not to be regarded as a departure from the intended scope of the present invention.

What is claimed is:

1. A method for managing digital video bandwidth, the method comprising:
establishing an available bandwidth for receiving video streams on a video connection;
receiving a request at a digital video receiver for a new video stream;
calculating that an amount of bandwidth required for a requested set of video streams that includes the new video stream would exceed the available bandwidth for receiving video streams;
selecting a proposed set of video streams, wherein
the new video stream is included in the proposed set of video streams,
a particular video stream of the requested set of video streams is not included in the proposed set of video streams, and
an amount of bandwidth required for the proposed set of video streams does not exceed the available bandwidth for receiving video streams;
identifying a consuming device of the particular video stream;
requesting permission from the consuming device to halt the particular video stream; and
configuring the video connection to transmit the new video stream after the permission is received from the consuming device to halt the particular video stream.

2. The method of claim 1, wherein the video connection is an internet protocol connection.

3. The method of claim 1, wherein the new video stream replaces an old video stream.

4. The method of claim 1, wherein the reception of the request for a new video stream comprises receiving a message from a remote control.

5. The method of claim 1, wherein the reception of the request for a new video stream comprises receiving a timer event.

6. The method of claim 1, wherein the calculation of the amount of bandwidth required for the requested set of video streams comprises:
communicating with at least one other digital video receiver that utilizes the video connection to determine a list of video streams being sent over the video connection; and
using an amount of bandwidth required by the new video stream and amounts of bandwidth used by the video streams of the list of video streams to calculate the amount of bandwidth required for the requested set of video stream.

7. The method of claim 6, wherein the amount of bandwidth required by the new video stream and the amounts of bandwidth used by the video streams of the list of video streams are looked up in a table.

8. The method of claim 6, wherein the amounts of bandwidth used by the video streams of the list of video streams are received from the at least one other digital video receiver.

9. The method of claim 1, wherein the selection of the proposed set of video streams comprises:
communicating with at least one other digital video receiver that utilizes the video connection to determine a list of video streams being sent over the video connection, and at least one parameter for the video streams of the list of video streams;
determining amounts of bandwidth required for the video streams of the list of video streams; and
choosing the particular video stream from the list of video streams being sent over the video connection based on
the at least one parameter for the video streams of the list of video streams, and
the amounts of bandwidth required for the video streams of the list of video streams.

10. The method of claim 9, wherein the at least one parameter for the video streams comprises a dwell time.

11. The method of claim 9, wherein the at least one parameter for the video streams comprises a priority level.

12. The method of claim 1, wherein the digital video receiver is the consuming device of the particular video stream.

13. The method of claim 1, further comprising:
configuring the video connection to receive the proposed set of video streams after a timeout period, wherein no response is received from the consuming device during the timeout period.

14. The method of claim 1 further comprising:
conveying a message from the consuming device, wherein the message asks for consent to halt the particular video stream; and
using a response to determine if the consuming device should send permission to halt the particular video stream.

15. The method of claim 1, further comprising:
halting the transmission of the particular video stream over the video connection.

16. The method of claim 1, further comprising:
tracking how often the available bandwidth for receiving video streams is less than the amount of bandwidth required for the requested set of video streams to create an upgrade indicator; and
offering information on upgrading the video connection if the upgrade indicator exceeds a threshold.

17. A digital video receiver comprising:
a network adapter configured to receive digital video streams sent using an internet protocol;
a processor, in communication with the network adapter;
a non-transitory processor readable storage medium, the non-transitory processor readable storage medium in communication with the processor and having processor readable program code suitable for execution on the processor embodied therewith, the processor readable program code comprising:
processor readable program code configured to establish an available bandwidth for receiving video streams on a video connection;
processor readable program code configured to receive a request for a new video stream;
processor readable program code configured to calculate that an amount of bandwidth required for a requested set of video streams that includes the new video stream would exceed the available bandwidth for receiving video streams;
processor readable program code configured to select a proposed set of video streams, wherein
the new video stream is included in the proposed set of video streams,
a particular video stream of the requested set of video streams is not included in the proposed set of video streams, and
an amount of bandwidth required for the proposed set of video streams does not exceed the available bandwidth for receiving video streams;
processor readable program code configured to identify a consuming device of the particular video stream;
processor readable program code configured to request permission from the consuming device to halt the particular video stream; and
processor readable program code configured to request the transmission of the new video stream over the video connection after the permission is received from the consuming device to halt the particular video stream.

18. The digital video receiver of claim 17, wherein the processor readable program code configured to select the proposed set of video streams comprises:
processor readable program code configured to communicate with at least one other digital video receiver that utilizes the video connection to determine a list of video streams being sent over the video connection, and at least one parameter for the video streams of the list of video streams;
processor readable program code configured to determine amounts of bandwidth required for the video streams of the list of video streams; and
processor readable program code configured to choose the particular video stream from the list of video streams being sent over the video connection based on
the at least one parameter for the video streams of the list of video streams, and
the amounts of bandwidth required for the video streams of the list of video streams.

19. The digital video receiver of claim 18, wherein the at least one parameter for the video streams comprises a dwell time.

20. The digital video receiver of claim 18, wherein the at least one parameter for the video streams comprises a priority level.

21. A digital video system comprising:
a first digital video receiver configured to connect to a network;
a second digital video receiver configured to connect to the network and receive a first digital video stream over the network;
wherein the first digital video receiver is further configured to:
(a) receive a request to initiate transfer of a requested video stream over the network;
(b) determine that an available bandwidth for receiving video would be exceeded if the requested video stream were to be transferred over the network;
(c) determine that halting the first digital video stream would allow the requested video stream to be transferred over the network without exceeding the available bandwidth for receiving video;
(d) communicate with the second digital video receiver, the communication with the second digital video receiver including a request that the first digital video stream be halted; and
(e) request that the transfer of the requested digital video stream over the network be started after the first digital video stream has been halted;
and the second digital video receiver is further configured to:
(f) receive the request from the first digital video receiver to halt the first digital video stream;
(g) convey a message indicating that the request to halt the first digital video stream has been received;
(h) receive a response to the message; and
(i) communicate with first digital video receiver about halting the first video stream.

22. The digital video system of claim 19, wherein the first digital video receiver is further configured to halt the first digital video stream after communicating with the second digital video receiver about halting the first video stream.

23. The digital video system of claim 19, wherein the second digital video receiver is further configured to halt the first digital video stream before communicating with the first digital video receiver about halting the first video stream.

24. The digital video system of claim 19, wherein the first digital video receiver is further configured to:
(j) query the second digital video receiver as to what video stream is being consumed by the second digital video receiver;
(k) query the second digital video receiver as to a dwell time of the video stream being consumed by the second digital video receiver; and
(l) use the dwell time of the video stream being consumed by the second digital video receiver in determining if the first digital video stream should be halted;
and the second digital video receiver is further configured to:
(m) track a dwell time of the first digital video stream;
(n) respond to a query from the first digital video receiver of what video stream is being consumed with information identifying the first video stream; and
(o) respond to a query from the first digital video receiver of the dwell time of the video stream being consumed with the dwell time of the first digital video stream.
